(19) United States
(12) Patent Application Publication
(10) Pub. No.: US 2012/0223885 A1
(43) Pub. Date: Sep. 6, 2012

(54) IMMERSIVE DISPLAY EXPERIENCE

(75) Inventor: Gritsko Perez, Snohomish, WA (US)

(73) Assignee: MICROSOFT CORPORATION, Redmond, WA (US)

(21) Appl. No.: 13/039,179

(22) Filed: Mar. 2, 2011

(51) Int. Cl. G06F 3/033; G06T 15/00

(52) U.S. Cl. 345/158; 345/419

(57) ABSTRACT

A data-holding subsystem holding instructions executable by a logic subsystem is provided. The instructions are configured to output a primary image to a primary display for display by the primary display, and output a peripheral image to an environmental display for projection by the environmental display on an environmental surface of a display environment so that the peripheral image appears as an extension of the primary image.

### BACKGROUND

User enjoyment of video games and related media experiences can be increased by making the gaming experience more realistic. Previous attempts to make the experience more realistic have included switching from two-dimensional to three-dimensional animation techniques, increasing the resolution of game graphics, producing improved sound effects, and creating more natural game controllers.

### SUMMARY

An immersive display environment is provided to a human user by projecting a peripheral image onto environmental surfaces around the user. The peripheral images serve as an extension to a primary image displayed on a primary display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an embodiment of an immersive display environment.

FIG. 2 shows an example method of providing a user with an immersive display experience.

FIG. 3 schematically shows an embodiment of a peripheral image displayed as an extension of a primary image.

FIG. 4 schematically shows an example shielded region of a peripheral image, the shielded region shielding display of the peripheral image at the user position.

FIG. 5 schematically shows the shielded region of FIG. 4 adjusted to track a movement of the user at a later time.

FIG. 6 schematically shows an interactive computing system according to an embodiment of the present disclosure.

### DETAILED DESCRIPTION

Interactive media experiences, such as video games, are commonly delivered by a high quality, high resolution display. Such displays are typically the only source of visual content, so that the media experience is bounded by the bezel of the display. Even when focused on the display, the user may perceive architectural and decorative features of the room the display is in via the user's peripheral vision. Such features are typically out of context with respect to the displayed image, muting the entertainment potential of the media experience. Further, because some entertainment experiences engage the user's situational awareness (e.g., in experiences like the video game scenario described above), the ability to perceive motion and identify objects in the peripheral environment (i.e., in a region outside of the high resolution display) may intensify the entertainment experience.

Various embodiments are described herein that provide the user with an immersive display experience by displaying a primary image on a primary display and a peripheral image that appears, to the user, to be an extension of the primary image.

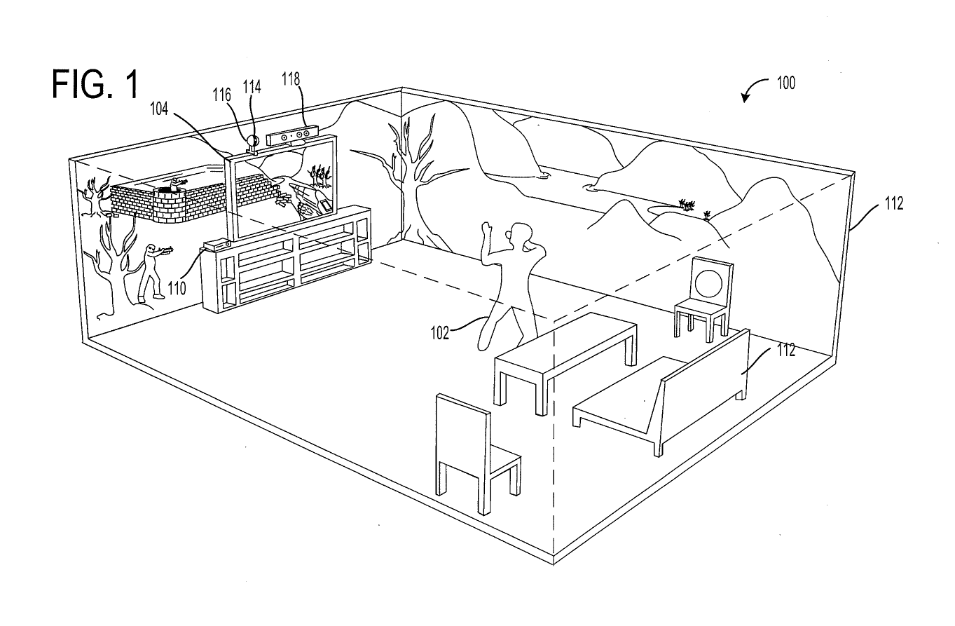

FIG. 1 schematically shows an embodiment of a display environment 100. Display environment 100 is depicted as a room configured for leisure and social activities in a user's home. In the example shown in FIG. 1, display environment 100 includes furniture and walls, though it will be understood that various decorative elements and architectural fixtures not shown in FIG. 1 may also be present.

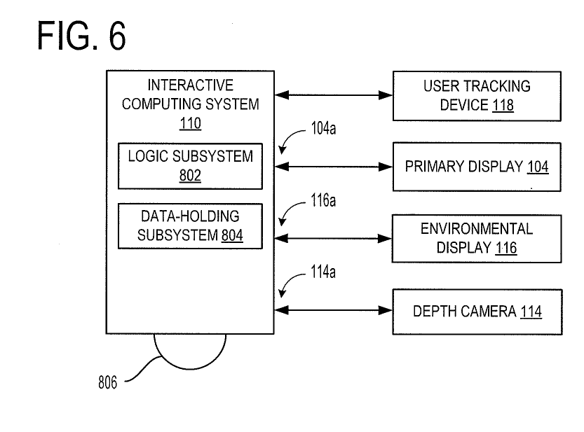

As shown in FIG. 1, a user 102 is playing a video game using an interactive computing system 110 (such as a gaming console) that outputs a primary image to primary display 104 and projects a peripheral image on environmental surfaces (e.g., walls, furniture, etc.) within display environment 100 via environmental display 116. An embodiment of interactive computing system 110 will be described in more detail below with reference to FIG. 6.

In the example shown in FIG. 1, a primary image is displayed on primary display 104. As depicted in FIG. 1, primary display 104 is a flat panel display, though it will be appreciated that any suitable display may be used for primary display 104 without departing from the scope of the present disclosure. In the gaming scenario shown in FIG. 1, user 102 is focused on primary images displayed on primary display 104. For example, user 102 may be engaged in attacking video game enemies that are shown on primary display 104.

As depicted in FIG. 1, interactive computing system 110 is operatively connected with various peripheral devices. For example, interactive computing system 110 is operatively connected with an environmental display 116, which is configured to display a peripheral image on environmental surfaces of the display environment. The peripheral image is configured to appear to be an extension of the primary image displayed on the primary display when viewed by the user. Thus, environmental display 116 may project images that have the same image context as the primary image. As a user perceives the peripheral image with the user's peripheral vision, the user may be situationally aware of images and objects in the peripheral vision while being focused on the primary image.

In the example shown in FIG. 1, user 102 is focused on the wall displayed on primary display 104 but may be aware of an approaching video game enemy from the user's perception of the peripheral image displayed on environmental surface 112. In some embodiments, the peripheral image is configured so that, to a user, the peripheral image appears to surround the user when projected by the environmental display. Thus, in the context of the gaming scenario shown in FIG. 1, user 102 may turn around and observe an enemy sneaking up from behind.

In the embodiment shown in FIG. 1, environmental display 116 is a projection display device configured to project a peripheral image in a 360-degree field around environmental display 116. In some embodiments, environmental display 116 may include one each of a left-side facing and a right-side facing (relative to the frontside of primary display 104) wide-angle RGB projector. In FIG. 1, environmental display 116 is located on top of primary display 104, although this is not required. The environmental display may be located at another position proximate to the primary display, or in a position away from the primary display.

While the example primary display 104 and environmental display 116 shown in FIG. 1 include 2-D display devices, it will be appreciated that suitable 3-D displays may be used without departing from the scope of the present disclosure. For example, in some embodiments, user 102 may enjoy an immersive 3-D experience using suitable headgear, such as active shutter glasses (not shown) configured to operate in synchronization with suitable alternate-frame image sequencing at primary display 104 and environmental display 116. In some embodiments, immersive 3-D experiences may be provided with suitable complementary color glasses used to view suitable stereographic images displayed by primary display 104 and environmental display 116.

In some embodiments, user 102 may enjoy an immersive 3-D display experience without using headgear. For example, primary display 104 may be equipped with suitable parallax barriers or lenticular lenses to provide an autostereoscopic display while environmental display 116 renders parallax views of the peripheral image in suitably quick succession to accomplish a 3-D display of the peripheral image via “wiggle” stereoscopy. It will be understood that any suitable combination of 3-D display techniques including the approaches described above may be employed without departing from the scope of the present disclosure. Further, it will be appreciated that, in some embodiments, a 3-D primary image may be provided via primary display 104 while a 2-D peripheral image is provided via environmental display 116 or the other way around.

Interactive computing system 110 is also operatively connected with a depth camera 114. In the embodiment shown in FIG. 1, depth camera 114 is configured to generate three-dimensional depth information for display environment 100. For example, in some embodiments, depth camera 114 may be configured as a time-of-flight camera configured to determine spatial distance information by calculating the difference between launch and capture times for emitted and reflected light pulses. Alternatively, in some embodiments, depth camera 114 may include a three-dimensional scanner configured to collect reflected structured light, such as light patterns emitted by a MEMS laser or infrared light patterns projected by an LCD, LCOS, or DLP projector. It will be understood that, in some embodiments, the light pulses or structured light may be emitted by environmental display 116 or by any suitable light source.

In some embodiments, depth camera 114 may include a plurality of suitable image capture devices to capture three-dimensional depth information within display environment 100. For example, in some embodiments, depth camera 114 may include each of a forward-facing and a backward-facing (relative to a front-side primary display 104 facing user 102) fisheye image capture device configured to receive reflected light from display environment 100 and provide depth information for a 360-degree field of view surrounding depth camera 114. Additionally or alternatively, in some embodiments, depth camera 114 may include image processing software configured to stitch a panoramic image from a plurality of captured images. In such embodiments, multiple image capture devices may be included in depth camera 114.

As explained below, in some embodiments, depth camera 114 or a companion camera (not shown) may also be configured to collect color information from display environment 100, such as by generating color reflectivity information from collected RGB patterns. However, it will be appreciated that other suitable peripheral devices may be used to collect and generate color information without departing from the scope of the present disclosure. For example, in one scenario, color information may be generated from images collected by a CCD video camera operatively connected with interactive computing system 110 or depth camera 114.

In the embodiment shown in FIG. 1, depth camera 114 shares a common housing with environmental display 116. By sharing a common housing, depth camera 114 and environmental display 116 may have a near-common perspective, which may enhance distortion-correction in the peripheral image relative to conditions where depth camera 114 and environmental display 116 are located farther apart. However, it will be appreciated that depth camera 114 may be a standalone peripheral device operatively coupled with interactive computing system 110.

As shown in the embodiment of FIG. 1, interactive computing system 110 is operatively connected with a user tracking device 118. User tracking device 118 may include a suitable depth camera configured to track user movements and features (e.g., head tracking, eye tracking, body tracking, etc.). In turn, interactive computing system 110 may identify and track a user position for user 102, and act in response to user movements detected by user tracking device 118. Thus, gestures performed by user 102 while playing a video game running on interactive computing system 110 may be recognized and interpreted as game controls. In other words, the tracking device 118 allows the user to control the game without the use of conventional, hand-held game controllers. In some embodiments where a 3-D image is presented to a user, user tracking device 118 may track a user's eyes to determine a direction of the user's gaze. For example, a user's eyes may be tracked to comparatively improve the appearance of an image displayed by an autostereoscopic display at primary display 104 or to comparatively enlarge the size of a stereoscopic “sweet spot” of an autostereoscopic display at primary display 104 relative to approaches where a user's eyes are not tracked.

It will be appreciated that, in some embodiments, user tracking device 118 may share a common housing with environmental display 116 and/or depth camera 114. In some embodiments, depth camera 114 may perform all of the functions of user tracking device 118, or in the alternative, user tracking device 118 may perform all of the functions of depth camera 114. Furthermore, one or more of environmental display 116, depth camera 114, and tracking device 118 may be integrated with primary display 104.

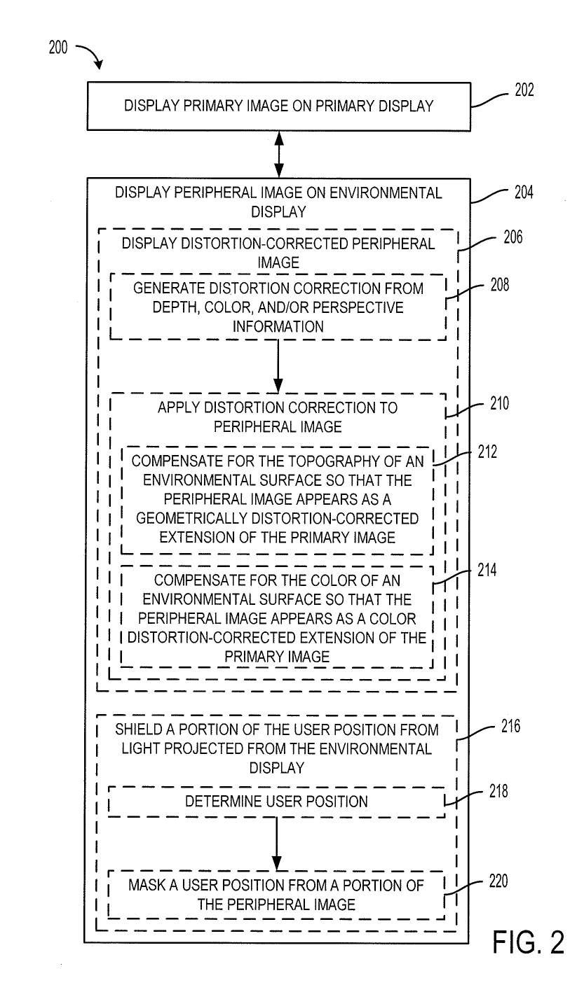

FIG. 2 shows a method 200 of providing a user with an immersive display experience. It will be understood that embodiments of method 200 may be performed using suitable hardware and software such as the hardware and software described herein. Further, it will be appreciated that the order of method 200 is not limiting.

At 202, method 200 comprises displaying the primary image on the primary display, and, at 204, displaying the peripheral image on the environmental display so that the peripheral image appears to be an extension of the primary image. Put another way, the peripheral image may include images of scenery and objects that exhibit the same style and context as scenery and objects depicted in the primary image, so that, within an acceptable tolerance, a user focusing on the primary image perceives the primary image and the peripheral image as forming a whole and complete scene. In some instances, the same virtual object may be partially displayed as part of the primary image and partially displayed as part of the peripheral image.

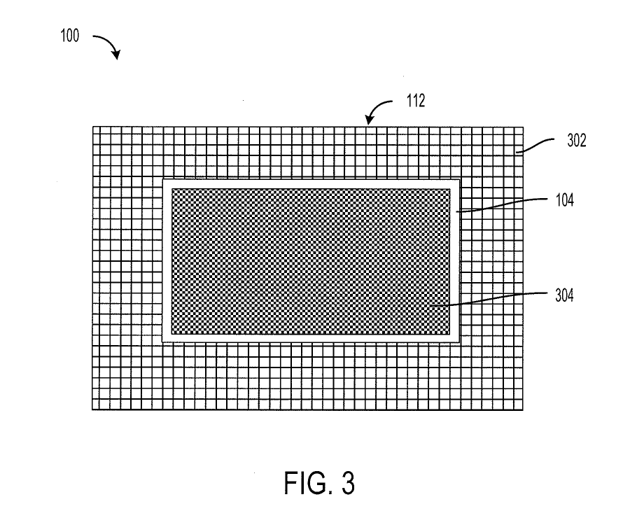

Because a user may be focused and interacting with images displayed on the primary display, in some embodiments, the peripheral image may be displayed at a lower resolution than the primary image without adversely affecting user experience. This may provide an acceptable immersive display environment while reducing computing overhead. For example, FIG. 3 schematically shows an embodiment of a portion of display environment 100 and an embodiment of primary display 104. In the example shown in FIG. 3, peripheral image 302 is displayed on an environmental surface 112 behind primary display 104 while a primary image 304 is displayed on primary display 104. Peripheral image 302 has a lower resolution than primary image 304, schematically illustrated in FIG. 3 by a comparatively larger pixel size for peripheral image 302 than for primary image 304.

Turning back to FIG. 2, in some embodiments, method 200 may comprise, at 206, displaying a distortion-corrected peripheral image. In such embodiments, the display of the peripheral image may be adjusted to compensate for the topography and/or color of environmental surfaces within the display environment.

In some of such embodiments, topographical and/or color compensation may be based on a depth map for the display environment used for correcting topographical and geometric distortions in the peripheral image and/or by building a color map for the display environment used for correcting color distortions in the peripheral image. Thus, in such embodiments, method 200 includes, at 208, generating distortion correction from depth, color, and/or perspective information related to the display environment, and, at 210 applying the distortion correction to the peripheral image. Non-limiting examples of geometric distortion correction, perspective distortion correction, and color distortion corrected are described below.

In some embodiments, applying the distortion correction to the peripheral image 210 may include, at 212, compensating for the topography of an environmental surface so that the peripheral image appears as a geometrically distortion-corrected extension of the primary image. For example, in some embodiments, geometric distortion correction transformations may be calculated based on depth information and applied to the peripheral image prior to projection to compensate for the topography of environmental surfaces. Such geometric distortion correction transformations may be generated in any suitable way.

In some embodiments, depth information used to generate a geometric distortion correction may be generated by projecting structured light onto environmental surfaces of the display environment and building a depth map from reflected structured light. Such depth maps may be generated by a suitable depth camera configured to measure the reflected structured light (or reflected light pulses in scenarios where a time-of-flight depth camera is used to collect depth information).

For example, structured light may be projected on walls, furniture, and decorative and architectural elements of a user's entertainment room. A depth camera may collect structured light reflected by a particular environmental surface to determine the spatial position of the particular environmental surface and/or spatial relationships with other environmental surfaces within the display environment. The spatial positions for several environmental surfaces within the display environment may then be assembled into a depth map for the display environment. While the example above refers to structured light, it will be understood that any suitable light for building a depth map for the display environment may be used. Infrared structured light may be used in some embodiments, while non-visible light pulses configured for use with a time-of-flight depth camera may be used in some other embodiments. Furthermore, time-of-flight depth analysis may be used without departing from the scope of this disclosure.

Once the geometric distortion correction is generated, it may be used by an image correction processor configured to adjust the peripheral image to compensate for the topography of the environmental surface described by the depth information. The output of the image correction processor is then output to the environmental display so that the peripheral image appears as a geometrically distortion-corrected extension of the primary image.

For example, because an uncorrected projection of horizontal lines displayed on a cylindrically-shaped lamp included in a display environment would appear as half-circles, an interactive computing device may multiply the portion of the peripheral image to be displayed on the lamp surface by a suitable correction coefficient. Thus, pixels for display on the lamp may be adjusted, prior to projection, to form a circularly-shaped region. Once projected on the lamp, the circularly-shaped region would appear as horizontal lines.

In some embodiments, user position information may be used to adjust an apparent perspective of the peripheral image display. Because the depth camera may not be located at the user's location or at the user's eye level, the depth information collected may not represent the depth information perceived by the user. Put another way, the depth camera may not have the same perspective of the display environment as the user has, so that the geometrically corrected peripheral image may still appear slightly incorrect to the user. Thus, in some embodiments, the peripheral image may be further corrected so that the peripheral image appears to be projected from the user position. In such embodiments, compensating for the topography of the environmental surface at 212 may include compensating for a difference between a perspective of the depth camera at the depth camera position and the user's perspective at the user's position. In some embodiments, the user's eyes may be tracked by the depth camera or other suitable tracking device to adjust the perspective of the peripheral image.

In some embodiments where a 3-D peripheral image is displayed by the environmental display to a user, the geometric distortion correction transformations described above may include suitable transformations configured to accomplish the 3-D display. For example, the geometric distortion correction transformations may include transformations correct for the topography of the environmental surfaces while providing alternating views configured to provide a parallax view of the peripheral image.

In some embodiments, applying the distortion correction to the peripheral image 210 may include, at 214, compensating for the color of an environmental surface so that the peripheral image appears as a color distortion-corrected extension of the primary image. For example, in some embodiments, color distortion correction transformations may be calculated based on color information and applied to the peripheral image prior to projection to compensate for the color of environmental surfaces. Such color distortion correction transformations may be generated in any suitable way.

In some embodiments, color information used to generate a color distortion correction may be generated by projecting a suitable color pattern onto environmental surfaces of the display environment and building a color map from reflected light. Such color maps may be generated by a suitable camera configured to measure color reflectivity.

For example, an RGB pattern (or any suitable color pattern) may be projected on to the environmental surfaces of the display environment by the environmental display or by any suitable color projection device. Light reflected from environmental surfaces of the display environment may be collected (for example, by the depth camera). In some embodiments, the color information generated from the collected reflected light may be used to build a color map for the display environment.

For example, based on the reflected RGB pattern, the depth camera may perceive that the walls of the user's entertainment room are painted blue. Because an uncorrected projection of blue light displayed on the walls would appear uncolored, the interactive computing device may multiply the portion of the peripheral image to be displayed on the walls by a suitable color correction coefficient. Specifically, pixels for display on the walls may be adjusted, prior to projection, to increase a red content for those pixels. Once projected on the walls, the peripheral image would appear to the user to be blue.

In some embodiments, a color profile of the display environment may be constructed without projecting colored light onto the display environment. For example, a camera may be used to capture a color image of the display environment under ambient light, and suitable color corrections may be estimated.

In some embodiments where a 3-D peripheral image is displayed by the environmental display to a user wearing 3-D headgear, the color distortion correction transformations described above may include suitable transformations configured to accomplish the 3-D display. For example, the color distortion correction transformations may be adjusted to provide a 3-D display to a user wearing glasses having colored lenses, including, but not limited to, amber and blue lenses or red and cyan lenses.

It will be understood that distortion correction for the peripheral image may be performed at any suitable time and in any suitable order. For example, distortion correction may occur at the startup of an immersive display activity and/or at suitable intervals during the immersive display activity. For example, distortion correction may be adjusted as the user moves around within the display environment, as light levels change, etc.

In some embodiments, displaying the peripheral image by the environmental display 204 may include, at 216, shielding a portion of the user position from light projected by the environmental display. In other words, projection of the peripheral image may be actually and/or virtually masked so that a user will perceive relatively less light shining from the peripheral display to the user position. This may protect the user's eyesight and may avoid distracting the user when moving portions of the peripheral image appear to be moving along the user's body.

In some of such embodiments, an interactive computing device tracks a user position using the depth input received from the depth camera and outputs the peripheral image so that a portion of the user position is shielded from peripheral image light projected from the environmental display. Thus, shielding a portion of the user position 216 may include determining the user position at 218. For example, a user position may be received from a depth camera or other suitable user tracking device. Optionally, in some embodiments, receiving the user position may include receiving a user outline. Further, in some embodiments, user position information may also be used to track a user's head, eyes, etc. when performing the perspective correction described above.

The user position and/or outline may be identified by the user's motion relative to the environmental surfaces of the display environment, or by any suitable detection method. The user position may be tracked over time so that the portion of the peripheral image that is shielded tracks changes in the user position.

While the user's position is tracked within the display environment, the peripheral image is adjusted so that the peripheral image is not displayed at the user position. Thus, shielding a portion of the user position at 216 may include, at 220, masking a user position from a portion of the peripheral image. For example, because the user position within the physical space of the display environment is known, and because the depth map described above includes a three-dimensional map of the display environment and of where particular portions of the peripheral image will be displayed within the display environment, the portion of the peripheral image that would be displayed at the user position may be identified.

Once identified, that portion of the peripheral image may be shielded and/or masked from the peripheral image output. Such masking may occur by establishing a shielded region of the peripheral image, within which light is not projected. For example, pixels in a DLP projection device may be turned off or set to display black in the region of the user's position. It will be understood that corrections for the optical characteristics of the projector and/or for other diffraction conditions may be included when calculating the shielded region. Thus, the masked region at the projector may have a different appearance from the projected masked region.

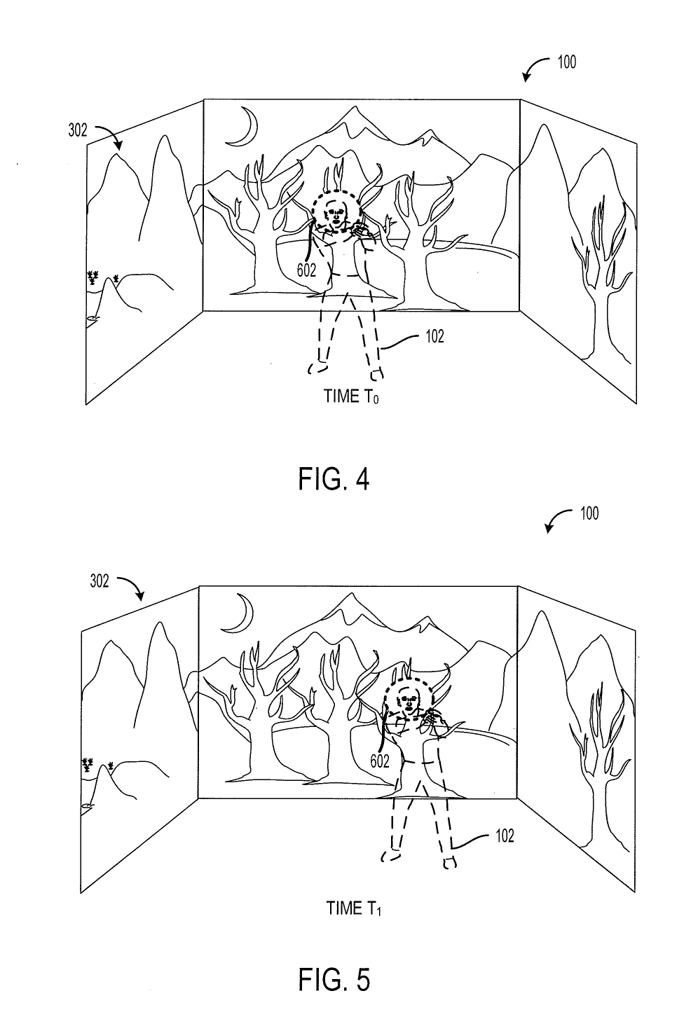

FIGS. 4 and 5 schematically show an embodiment of a display environment 100 in which a peripheral image 302 is being projected at time T₀ (FIG. 4) and at a later time T₁ (FIG. 5). For illustrative purposes, the outline of user 102 is shown in both figures, user 102 moving from left to right as time progresses. As explained above, a shielded region 602 (shown in outline for illustrative purposes only) tracks the user's head, so that projection light is not directed into the user's eyes. While FIGS. 4 and 5 depict shielded region 602 as a roughly elliptical region, it will be appreciated that shielded region 602 may have any suitable shape and size. For example, shielded region 602 may be shaped according to the user's body shape (preventing projection of light onto other portions of the user's body). Further, in some embodiments, shielded region 602 may include a suitable buffer region. Such a buffer region may prevent projected light from leaking onto the user's body within an acceptable tolerance.

In some embodiments, the above described methods and processes may be tied to a computing system including one or more computers. In particular, the methods and processes described herein may be implemented as a computer application, computer service, computer API, computer library, and/or other computer program product.

FIG. 6 schematically shows embodiments of primary display 104, depth camera 114, environmental display 116, and user tracking device 118 operatively connected with interactive computing system 110. In particular, a peripheral input 114a operatively connects depth camera 114 to interactive computing system 110; a primary display output 104a operatively connects primary display 104 to interactive computing system 110; and an environmental display output 116a operatively connects environmental display 116 to interactive computing system 110. As introduced above, one or more of user tracking device 118, primary display 104, environmental display 116, and/or depth camera 114 may be integrated into a multi-functional device. As such, one or more of the above described connections may be multi-functional. In other words, two or more of the above described connections can be integrated into a common connection. Nonlimiting examples of suitable connections include USB, USB 2.0, IEEE 1394, HDMI, 802.11x, and/or virtually any other suitable wired or wireless connection.

Interactive computing system 110 is shown in simplified form. It is to be understood that virtually any computer architecture may be used without departing from the scope of this disclosure. In different embodiments, interactive computing system 110 may take the form of a mainframe computer, server computer, desktop computer, laptop computer, tablet computer, home entertainment computer, network computing device, mobile computing device, mobile communication device, gaming device, etc.

Interactive computing system 110 includes a logic subsystem 802 and a data-holding subsystem 804. Interactive computing system 110 may also optionally include user input devices such as keyboards, mice, game controllers, cameras, microphones, and/or touch screens, for example.

Logic subsystem 802 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 804 may include one or more physical, non-transitory, devices configured to hold data and/or instructions executable by the logic subsystem to implement the herein described methods and processes. When such methods and processes are implemented, the state of data-holding subsystem 804 may be transformed (e.g., to hold different data).

Data-holding subsystem 804 may include removable media and/or built-in devices. Data-holding subsystem 804 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem ?? may include devices with one or more of the following characteristics: volatile, nonvolatile, dynamic, static, read/write, read-only, random access, sequential access, location addressable, file addressable, and content addressable. In some embodiments, logic subsystem 802 and data-holding subsystem 804 may be integrated into one or more common devices, such as an application specific integrated circuit or a system on a chip.

FIG. 6 also shows an aspect of the data-holding subsystem in the form of removable computer-readable storage media 806 which may be used to store and/or transfer data and/or instructions executable to implement the herein described methods and processes. Removable computer-readable storage media ?? may take the form of CDs, DVDs, HD-DVDs, Blu-Ray Discs, EEPROMs, and/or floppy disks, among others.

It is to be appreciated that data-holding subsystem 804 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

In some cases, the methods described herein may be instantiated via logic subsystem 802 executing instructions held by data-holding subsystem 804. It is to be understood that such methods may take the form of a module, a program and/or an engine. In some embodiments, different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An interactive computing system configured to provide an immersive display experience within a display environment, the system comprising:
a peripheral input configured to receive depth input from a depth camera;
a primary display output configured to output a primary image to a primary display device;
an environmental display output configured to output a peripheral image to an environmental display;
a logic subsystem operatively connectable to the depth camera via the peripheral input, to the primary display via the primary display output, and to the environmental display via the environmental display output; and
a data-holding subsystem holding instructions executable by the logic subsystem to:
within the display environment, track a user position using the depth input received from the depth camera, and
output a peripheral image to the environmental display for projection onto an environmental surface of the display environment so that the peripheral image appears as an extension of the primary image and shields a portion of the user position from light projected from the environmental display.

2. The system of claim 1, wherein the depth camera is configured to detect depth information by measuring structured non-visible light reflected from the environmental surface.

3. The system of claim 1, further comprising instructions to:
receive one or more of depth information and color information for the display environment from the depth camera; and
display the peripheral image on the environmental surface of the display environment so that the peripheral image appears as a distortion-corrected extension of the primary image.

4. The system of claim 3, further comprising instructions to compensate for topography of the environmental surface described by the depth information so that the peripheral image appears as a geometrically distortion-corrected extension of the primary image.

5. The system of claim 3, wherein a camera is configured to detect color information by measuring color reflectivity from the environmental surface.

6. The system of claim 5, further comprising instructions to compensate for a color of the environmental surface described by the color information so that the peripheral image appears as a color distortion-corrected extension of the primary image.

7. A data-holding subsystem holding instructions executable by a logic subsystem, the instructions configured to provide an immersive display experience within a display environment, the instructions configured to:
output a primary image to a primary display for display by the primary display, and
output a peripheral image to an environmental display for projection by the environmental display on an environmental surface of a display environment so that the peripheral image appears as an extension of the primary image, the peripheral image having a lower resolution than the primary image.

8. The subsystem of claim 7, wherein the peripheral image is configured so that, to a user, the peripheral image appears to surround the user when projected by the environmental display.

9. The subsystem of claim 7, further comprising instructions to, within the display environment, track a user position using depth information received from a depth camera, wherein the output of the peripheral image is configured to shield a portion of the user position from light projected from the environmental display.

10. The subsystem of claim 9, wherein the depth camera is configured to detect depth information by measuring structured non-visible light reflected from the environmental surface.

11. The subsystem of claim 7, further comprising instructions to receive one or more of depth information and color information for the display environment from the depth camera, wherein the output of the peripheral image on the environmental surface of the display environment is configured so that the peripheral image appears as a distortion-corrected extension of the primary image.

12. The subsystem of claim 11, further comprising instructions to compensate for topography of the environmental surface described by the depth information so that the peripheral image appears as a geometrically distortion-corrected extension of the primary image.

13. The subsystem of claim 11, further comprising instructions to compensate for a difference between a perspective of the depth camera at a depth camera position and a user's perspective at the user position.

14. The subsystem of claim 11, wherein the depth camera is configured to detect color information by measuring color reflectivity from the environmental surface.

15. The subsystem of claim 14, further comprising instructions to compensate for a color of the environmental surface described by the color information so that the peripheral image appears as a color distortion-corrected extension of the primary image.

16. An interactive computing system configured to provide an immersive display experience within a display environment, the system comprising:
a peripheral input configured to receive one or more of color and depth input for the display environment from a camera;
a primary display output configured to output a primary image to a primary display device;
an environmental display output configured to output a peripheral image to an environmental display;
a logic subsystem operatively connectable to the camera via the peripheral input, to the primary display via the primary display output, and to the environmental display via the environmental display output; and
a data-holding subsystem holding instructions executable by the logic subsystem to:
output a peripheral image to the environmental display for projection onto an environmental surface of the display environment so that the peripheral image appears as a distortion-corrected extension of the primary image.

17. The system of claim 16, wherein the camera is configured to detect depth information by measuring structured non-visible light reflected from the environmental surface.

18. The system of claim 17, further comprising instructions to compensate for topography of the environmental surface described by the depth information so that the peripheral image appears as a geometrically distortion-corrected extension of the environmental surface.

19. The system of claim 16, wherein the camera is configured to detect color information by measuring color reflectivity from the environmental surface.

20. The system of claim 19, further comprising instructions to compensate for a color of the environmental surface described by the color information so that the peripheral image appears as a color distortion-corrected extension of the primary image.
